(19) United States
(12) Patent Application Publication
(10) Pub. No.: US 2005/0074531 A1
(43) Pub. Date: Apr. 7, 2005

(54) Gas control packaging

(76) Inventor: Miles Roylance Patterson, Hastings (NZ)

Correspondence Address: JACOBSON HOLMAN, 400 SEVENTH STREET, N.W., WASHINGTON, DC, 20004, US

(21) Appl. No.: 10/637,037

(22) Filed: Aug. 8, 2003

(30) Foreign Application Priority Data
Aug. 9, 2002 (NZ) 520678

(51) Int. Cl. A23B 4/00

(52) U.S. Cl. 426/129

(57) ABSTRACT

A tray including a moulded tray form defining a base, an upstanding peripheral wall or upstanding peripheral walls from the base to define a containment region, and a peripheral rim at the distal extremity of the wall(s). There is set down in the peripheral rim at least one recess adapted to and/or which will allow gas exchange from the containment region of the tray form to the outside of the tray form, and/or vice versa when the peripheral rim is lidded by a lidding means such as a wrap enveloping the tray form, itself having a ventilation feature for gas exchange through the wrap away from the peripheral rim and the containment region lidding portion of the wrap, or a lidding sheet affixed to the peripheral rim but not down into the recess(es) to allow for a ventilation opening to remain via the at least one recess between the containment region and the outside of the tray form.

The present invention relates to gas control packaging, components therefor (e.g. trays, wraps, lidding films, and/or barrier bags), assemblies thereof and to related methods, packs and uses.

### BACKGROUND

Various forms of packaging produce such as fresh meat are known.

U.S. Pat. Nos. 4,685,274 and 5,522,53, both issued to Anthony J. M. Garwood, disclose a packaging system for fresh meat which utilizes a specially constructed retail case-ready tray for prolonging the shelf life of the fresh meat product. Garwood teaches that the tray may be constructed of a gas barrier plastic material. The packaging system of Garwood further includes a laminated web of gas permeable clear flexible plastic wrap material which seals the meat within the tray and a lid which forms a domed enclosure over the laminated web. In use, the packaging is evacuated of normal atmosphere and is flushed with a gas mixture of carbon dioxide and nitrogen to preserve the contents. When the dome is pulled off, oxygen is allowed to contact the meat and the product blooms.

U.S. Pat. No. 5,711,978 (Transhumance) discloses a package for packaging fresh meat in a substantially oxygen-free atmosphere, whereby the packaging provides for a prolonged shelf life of the packaged meat products so that the meat will bloom to a desired red colour when the packaging is opened.

The packaging of U.S. Pat. No. 5,711,978 includes a packing tray which is sized for receiving a piece of fresh meat of predetermined cut. The tray is overwrapped with a web of clear plastic wrapping material. The overwrapped tray is ventilated to ensure gas communication between enclosed regions of the overwrapped tray and the outside ambient without blockage due to run off juices from the meat product or shifting of the meat product within the tray during transport.

A number of similarly ventilated overwrapped trays are then placed within an outer barrier bag which is first evacuated of normal atmosphere and then flushed with a preservation-enhancing gas. The outer barrier bag is then sealed.

Upon opening of the outer barrier bag, exposure to oxygen causes the packaged meat products to bloom to a desired fiery red color. Upon removal from the outer barrier bag, the ventilated overwrapped trays of U.S. Pat. No. 5,711,978 are ready for retail case-ready display without the need for repackaging or cosmetic repair.

PCT/US96/16117 (Transhumance) published as WO97/14313 there is disclosed a variant of the aforementioned Transhumance overwrapped trays where a tray sized for receiving a piece of fresh meat whether directly on the tray or a soaker pad is disclosed, the tray having strategically placed perforations. Whilst it is stated that advantageously the placement of the perforations in the tray are not readily visible to a casual observer (e.g. through the overwrapping which is of transparent plastics material) there is disclosed a tray form which includes at corner regions an upper recessed step portion in which holes are punched or otherwise are formed. Such holes can be in addition to additional holes. The present invention is directed to variants of such tray forms and their use in a packaging system where the tray is lidded either with a surrounding wrap as in the aforementioned Transhumance patent specifications or is instead lidded with a peripherally fixed lidding film, the fixing (e.g. adhesively, heat sealed or otherwise) being two a surrounding rim of the tray.

Accordingly it is an object of the present invention to provide a gas control package which has variants to the forms as defined in the prior art to at least provide the public with a useful choice.

### BRIEF DESCRIPTION OF THE INVENTION

Accordingly in a first aspect the present invention consists in a tray including a moulded tray form defining a base, an upstanding peripheral wall or upstanding peripheral walls from the base to define a containment region, and a peripheral rim at the distal extremity of the wall(s), wherein there is set down in the peripheral rim at least one recess adapted to and/or which will allow gas exchange from the containment region of the tray form to the outside of said tray form, and/or vice versa when the peripheral rim is lidded by a lidding means selected from one of
(i) a wrap enveloping said tray form, itself having a ventilation feature for gas exchange through the wrap away from the peripheral rim and the containment region lidding portion of the wrap, and
(ii) a lidding sheet affixed to the peripheral rim but not down into the recess(es) to allow for a ventilation opening to remain via said at least one recess between the containment region and the outside of said tray form.

Preferably said peripheral rim defines the general surround to said tray save for at least one said recess set down from said general surround of said peripheral rim being of a kind selected from any one or both of
i. at least one rebate in said peripheral rim, and
ii. at least one scallop in said peripheral rim.

Preferably said at least one recess is formed by a plateau set down inwardly of the periphery of said tray form in said peripheral rim.

Preferably said tray form has a quadrilateral shaped base and wherein at at least one corner at the periphery, at least one said recess is formed by a plateau set down inwardly of the periphery of said tray form in said peripheral rim.

Preferably said tray form has a quadrilateral shaped base and wherein at each corner at the periphery, at least one said recess is formed by a plateau set down inwardly of the periphery of said tray form in said peripheral rim.

Preferably said upstanding peripheral wall extends from said base, outwardly directed.

Preferably said peripheral rim extends outwardly from said upstanding peripheral wall and downwardly therefrom.

Preferably said peripheral rim is of a flat transverse cross section.

Preferably said peripheral rim is of a curve transverse cross sections.

Preferably said lidding sheet lies in a plane defined by the rim save for said recesse(s).

Preferably perforations extend through the upstanding peripheral wall.

Preferably the perforations are provided proximate more to said peripheral rim side of said upstanding peripheral wall than to the base side thereof.

Preferably at least one perforation is provided at the recess formed in a plateau setdown.

Preferably said tray form is moulded from a non oxygen retaining plastics material.

Preferably said tray form is moulded from a non oxygen retaining plastics material including a polymer selected from one of
i. High Impact Polystyrene (HIPS),
ii. Amorphous Polyethylene Terephalate (APET),
iii. Crystallised Polyethylene Terephalate (CPET),
iv. Polypropylene (PP),
v. Polyvinylchloride (PVC),
vi. Polyethylene (PE).

Preferably said tray form is moulded and includes a non oxygen retaining plastics material of a blend of polymers including one selected from
i. High Impact Polystyrene (HIPS),
ii. Amorphous Polyethylene Terephalate (APET),
iii. Crystallised Polyethylene Terephalate (CPET),
iv. Polypropylene (PP),
v. Polyvinylchloride (PVC),
vi. Polyethylene (PE).

Preferably said tray form is moulded from a non oxygen retaining assembly of plastics material layers including a co laminate layer selected from one of
i. High Impact Polystyrene (HIPS),
ii. Amorphous Polyethylene Terephalate (APET),
iii. Crystallised Polyethylene Terephalate (CPET),
iv. Polypropylene (PP),
v. Polyvinylchloride (PVC),
vi. Polyethylene (PE).

Preferably the tray form is moulded from an oxygen retaining plastic.

Preferably the tray form is moulded from a foamed plastics material whether foamed by means of direct gas injection or chemical reaction.

Preferably the tray form is moulded from an oxygen retaining plastic including a polymers selected form
i. General Purpose Polystyrene (GPPS),
ii. High Impact Polystyrene (HIPS),
iii. Amorphous Polyethylene Terephalate (APET),
iv. Crystallised Polyethylene Terephalate (CPET),
v. Polypropylene (PP), Polyethylene (PE).

Preferably said tray form is of a kind which where the oxygen is secured against migration to the meat.

Preferably the base is substantially rectangular and the recess(es) are in opposed distal regions of opposed upstanding walls.

In a second aspect the present invention consists in a meat package which comprises a tray as hereinbefore described wherein meat is positioned directly or indirectly on the base and within said containment region said lidding means is a clear plastics material provided over the meat.

Preferably said lidding means is a lidding sheet affixed to the peripheral rim and not providing a wrap of the tray form itself.

Preferably the lidding means is a wrap of a plastics film, and to enable gas interchange there is provided perforation in the wrap below the peripheral rim externally of the tray form.

Preferably the perforation of the wrap are outwardly of the upstanding peripheral wall(s).

Preferably the or additional perforation is provided of said wrap underneath the tray from and wherein there is a transition of the tray form from the base to upstanding peripheral wall(s) that will allow movement of gas between the wrap and the tray form at the base.

Preferably in addition perforations through the tray form itself are provided at the upstanding peripheral wall(s).

In a further aspect the present invention consists in a tray including a moulded tray form defined by a base, an upstanding peripheral wall or upstanding peripheral walls from the base to define a containment region, and a peripheral rim at the distal extremity of the wall(s), wherein there is set down inwardly of said peripheral rim at least one valved opening adapted to and/or which will allow gas exchange from the containment region of said tray form to the outside of said tray form, and/or vice versa, when the peripheral rim is lidded by a lidding means selected from one of
(i) a wrap enveloping said tray form, itself having a ventilation feature for gas exchange through the wrap away from the peripheral rim and the containment region lidding portion of the wrap, and
(ii) a lidding sheet affixed to the peripheral rim but not down to the valved opening(s) to allow for a ventilation opening to remain via said at least one valved opening(s) between the containment region and the outside of said tray form.

Preferably said tray form is moulded from a non oxygen retaining plastics material.

Preferably said tray form is moulded from a non oxygen retaining plastics material including a polymer selected from one of
(i) High Impact Polystyrene (HIPS),
(ii) Amorphous Polyethylene Terephalate (APET),
(iii) Crystallised Polyethylene Terephalate (CPET),
(iv) Polypropylene (PP),
(v) Polyvinylchloride (PVC),
(vi) Polyethylene (PE).

Preferably said tray form is moulded and includes a non oxygen retaining plastics material of a blend of polymers including one selected from
i. High Impact Polystyrene (HIPS),
ii. Amorphous Polyethylene Terephalate (APET),
iii. Crystallised Polyethylene Terephalate (CPET),
iv. Polypropylene (PP),
v. Polyvinylchloride (PVC),
vi. Polyethylene (PE).

Preferably said tray form is moulded from a non oxygen retaining assembly of plastics material layers including a co laminate layer selected from one of
i. High Impact Polystyrene (HIPS),
ii. Amorphous Polyethylene Terephalate (APET),
iii. Crystallised Polyethylene Terephalate (CPET),
iv. Polypropylene (PP),
v. Polyvinylchloride (PVC),
vi. Polyethylene (PE).

Preferably the tray form is moulded from an oxygen retaining plastic.

Preferably the tray form is moulded from a foamed plastics material whether foamed by means of direct gas injection or chemical reaction.

Preferably the tray form is moulded from an oxygen retaining plastic including a polymers selected form
i. General Purpose Polystyrene (GPPS),
ii. High Impact Polystyrene (HIPS),
iii. Amorphous Polyethylene Terephalate (APET),
iv. Crystallised Polyethylene Terephalate (CPET),
v. Polypropylene (PP), Polyethylene (PE).

Preferably said tray form is of a kind where the oxygen is secured against migration to the meat.

Preferably the lidding means is provided by a wrap of a clear plastics film.

Preferably said at least one opening is valved by a flap of the moulded material and substantially occludes the opening yet is capable of being moved resiliently to less occlude the opening under the action(s) of any induced gas exchange.

In still a further aspect the present invention consists in a meat package which comprises a tray as hereinbefore described wherein meat is positioned directly or indirectly on the tray base in said containment region and a said lidding means of a clear plastic film is provided over the meat.

Preferably said lidding means is a lidding sheet affixed to the peripheral rim and not providing a wrap of the tray form itself.

Preferably the lidding means is a wrap of a plastics film, and to enable gas interchange there is provided perforation in the wrap below the peripheral rim externally of the tray form.

Preferably the perforation of the wrap is outwardly of the upstanding peripheral wall(s).

Preferably the or additional perforation is provided of said wrap underneath the tray form and wherein there is a transition of the tray form from the base to upstanding peripheral wall(s) that will allow movement of gas between the wrap and the tray form at the base.

Preferably in addition perforations through the tray form itself are provided at the upstanding peripheral wall(s).

In still a further aspect the present invention consists in a tray including a moulded tray form defined by a base, an upstanding peripheral wall or upstanding peripheral walls from the base to define a containment region and a peripheral rim at the distal extremity of the wall(s), wherein there is set down internally of the peripheral rim at least one valved opening adapted to and/or which will allow gas exchange from the containment region of the tray form to the outside of said tray form, and/or vice versa, when the peripheral rim is lidded by a lidding means selected from one of:
(i) a wrap, enveloping said tray form, itself having a ventilation feature for gas exchange through the wrap away from the rim and the lidding portion of the wrap, and
(ii) a lidding sheet affixed to the peripheral rim but not down to the valved opening(s).

Preferably the or each valved opening is set down into a plateau formed in said upstanding peripheral wall(s).

Preferably said base is rectangular in shape and said plateau is in a corner of said upstanding peripheral wall(s) inwardly and down from the peripheral rim.

Preferably the valving element of each valved opening is a flap substantially in the plane or curvature of the opening which substantially occludes the opening except when moved from such an occluding condition by gas exchange flows, such movement preferably being resilient.

Preferably each such valved opening is of a form being a perforation through said tray form with which a flap is movable relative thereto to move between a perforation covering to a perforation uncovering condition to respectively close and open said valved opening and can be in addition to, or instead of, any other means to allow gas interchange inwardly and outwardly from the lidded tray in use.

In still a further aspect the present invention consists in a fresh packaged meat on a tray and/or on a soaker pad of a tray as hereinbefore described, the tray being lidded.

Preferably the lidding is with a lidding sheet or wrap.

In still a further aspect the present invention consists in a pack of meat of a kind where the meat is capable of blooming in the presence of oxygen, said pack comprising a container sealed to exclude ambient air, at least one meat package as hereinbefore described included within said container, and an atmosphere in the container and the or each meat package which is low or devoid in gaseous oxygen.

Preferably the gas environment internally of the container is high in carbon dioxide.

Preferably said container is a barrier bag that has been sealed.

In still a further aspect the present invention consists in any of the tray or meat pack forms substantially as herein described with reference to any one or more of the accompanying drawings.

As used herein the term “rim” in respect of the distal region of the peripheral wall(s) of the tray refers to the general surround save for any recesses, scallops or the like (“recesses”), if any, that might be formed down thereinto or any plateaux set down therefrom inwardly (e.g. into corners if the base is of a substantially rectangular or square or other like form having corners, eg as in 97/14313).

Generally speaking however the rim will be in the form of an outwardly extending flange which preferably, but not necessarily, is provided with a skirt that extends downwardly therefrom.

In some forms the flange region can be flat and others it can be curved or provided with complex cross sections. All such configurations are within the ambit of the term “rim”. For those forms of the tray not solely reliant upon gas exchange through a recess under the lidding panel (e.g. of a wrap or lidding sheet) perforations high in the wall(s) and/or in any plateaux inwardly and below the rim will be relied upon.

Preferably any such lidding panel lies in a plane generally defined by the majority of the rim.

In some forms of the present invention the tray is moulded from a non oxygen retaining plastics material eg a rigid plastics such as any polymers of, High Impact Polystyrene (HIPS), Amorphous Polyethylene Terephalate (APET), Crystallised Polyethylene Terephalate (CPET), Polypropylene (PP), Polyvinylchloride (PVC), Polyethylene (PE) or any blends, co-extrusions or laminations of such rigid polymers. In other forms the tray may be moulded from an oxygen retaining plastics form e.g. a foamed plastics material such as any polymers of, General Purpose Polystyrene (GPPS), High Impact Polystyrene (HIPS), Amorphous Polyethylene Terephalate (APET), Crystallised Polyethylene Terephalate (CPET), Polypropylene (PP), Polyethylene (PE) or any blends, co-extrusions or laminations of such polymers whether foamed by means of direct gas injection or chemical reaction.

The term “oxygen retaining” in respect of any material refers to a material that may include oxygen alone or in conjunction with other gases but in a form where the oxygen is secured against migration to the meat. For example, we propose foam plastics materials for the tray formation which whilst oxygen retaining nonetheless secure any oxygen within the cells of its foam matrix even after the tray of that material has been wrapped and/or lidded and gas flushed in the outer master pack (eg; an oxygen barrier bag as in the Transhumance patents mentioned). This ability to stop oxygen in the cells migrating to the meat will prevent discolouration associated with even low levels of oxygen in a CO₂ gas flushed pack.

In some forms of the present invention the perforation of the wrap can be outwardly of the wall(s) whilst in still other forms additionally or instead it can be underneath the tray provided there is a transition from base to wall(s) that will allow movement of gas between the wrap and the tray.

In still other forms of the present invention there can be a combination of routes for gas interchange to the recess or recesses and there can be, in addition, perforations into the tray itself.

Preferably the lidding was provided by a wrapping of a suitable plastics film such as for example described in the aforementioned Transhumance patents or alternatively it is lidded in a manner referred to in respect of the Garwood type patents and/or as disclosed hereinafter.

Preferably each such valved opening is of a form substantially as hereinafter described and can be in addition to, or instead of, any other means to allow gas interchange inwardly and outwardly from the lidded tray in use.

In yet a further aspect the present invention consists in a method of packing meat which comprises or includes any of the steps hereinafter described and results in a meat package of any of the kinds herein described.

In still a further aspect the present invention consists in any of the tray or meat pack forms substantially as herein described with reference to any one or more of the accompanying drawings.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

A preferred form of the present invention will now be described with reference (by way of reference to the aforementioned patent specifications) and the accompanying drawings in which,

FIG. 1A shows in perspective, and with partial breakaway of the lidding wrap, a tray having perforations in plateaux set down in each corner of the tray, and a wrap for the tray, the tray being formed of an oxygen retaining plastics material,

FIG. 1B showing perforations below and outside of the tray in the lidding wrap,

FIGS. 2A and 2B shows a similar arrangement to FIGS. 1A and 1B but where instead recesses are provided in the rim,

FIGS. 3A and 3B show yet a further variant of the arrangement shown in FIGS. 1A and 1B, this time showing a valved opening in each plateau,

FIGS. 4A and 4B are similar to FIGS. 2A and 2B save for the fact that the tray is moulded in a non oxygen retaining material unlike the tray as in FIGS. 2A and 2B,

FIGS. 5A and 5B are similar to FIGS. 3A and 3B except that the tray is formed from a non oxygen retaining material unlike the oxygen retaining material of FIGS. 3A and 3B,

FIGS. 6A and 6B are similar to the tray of FIG. 1A, however the lidding is with a lidding sheet affixed to the rim or tray flange and is not provided by a wrap, the tray being of an oxygen retaining material,

FIGS. 7A and 7B shows a tray form similar to that of FIG. 2A in that it is provided with the recesses and is of an oxygen retaining material but showing the same sealed with a lidding sheet as opposed to a wrap,

FIGS. 8A and 8B show a similar tray form to that of FIG. 3A, ie; with valved openings each in a plateau, the tray being formed of an oxygen retaining material but being lidded by a lidding sheet rather than a wrap,

FIGS. 9A and 9B show a tray form similar to that of FIG. 1A but when formed of a non oxygen retaining material and when being lidded with a lidding sheet as opposed to a wrap,

FIGS. 10A and 10B show a similar tray to that of FIG. 2A but where the tray is formed from a non oxygen retaining material and it is lidded by a lidding sheet rather than a wrap,

FIGS. 11A and 11B show a tray form similar to that of FIG. 3A but where the tray has been formed of a non oxygen retaining material as opposed to an oxygen retaining material and the lidding is with a lidding sheet affixed to the rim as opposed to a wrap,

FIG. 12 is a view through a master pack including a plurality of meat containing trays provided therein,

FIG. 13 is a view of FIG. 12 but wherein the contents has been flushed,

FIG. 14 is a close up view of a lower tray in the master pack in a condition after having been flushed according to FIG. 13 and wherein preservative gas has been introduced into the master pack or in a condition prior to flushing as for example shown in FIG. 12,

FIG. 15 is a close up view of a lower meat tray in the master pack in a condition where the oxygen is or has been flushed out of the master pack and the containment regions of the meat containing trays, and

FIG. 16 is a close up view of a meat containing tray in a condition where the meat containing tray is removed from the master pack and has been allowed to bloom by the ingress of oxygen containing air through the valved opening but wherein the valved opening is in a condition where the valve flap is positioned to avoid the spillage of juices which may be in the containment region out through the valved opening.

### DETAILED DESCRIPTION OF THE INVENTION

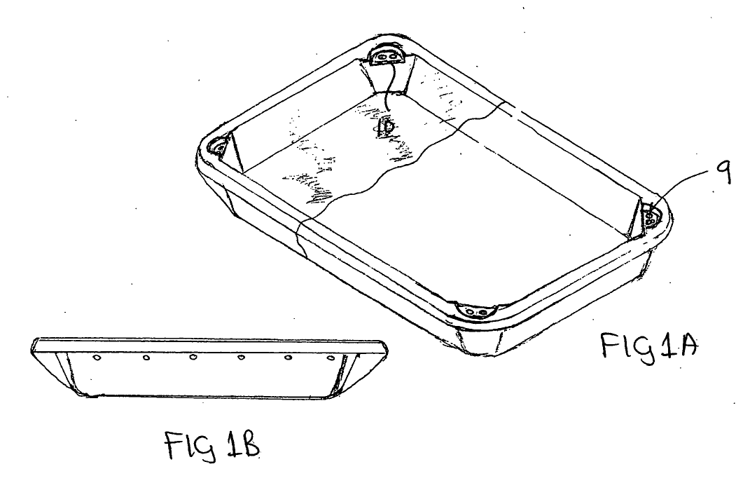

In the preferred form of the present invention the trays are formed by vacuum moulding if of a material that lends itself to vacuum moulding. A suitable vacuum mouldable material to provide a tray of a material that is oxygen retaining (as in FIGS. 1A, 2A, 3A, 6A, 7A and 8A) is a foamed plastics material selected from the suitable food grade thermoplastic material such as, for example, polymers of, General Purpose Polystyrene (GPPS), High Impact Polystyrene (HIPS), Amorphous Polyethylene Terephalate (APET), Crystallised Polyethylene Terephalate (CPET), Polypropylene (PP), Polyethylene (PE) or any blends, co-extrusions or laminations of such polymers whether foamed by means of direct gas injection or chemical reaction.

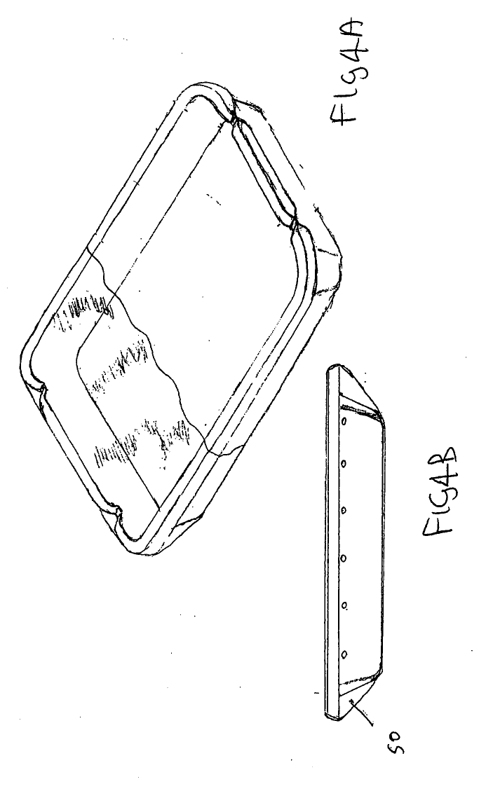

For the material characterised by reference to its being non oxygen retaining is meant any material such as polymers of, High Impact Polystyrene (HIPS), Amorphous Polyethylene Terephalate (APET), Crystallised Polyethylene Terephalate (CPET), Polypropylene (PP), Polyvinylchloride (PVC), Polyethylene (PE) or any blends, co-extrusions or laminations of such rigid polymers suitable for association with food, such materials being used in the tray form embodiments of FIGS. 4A, 5A, 9A, 10A and 11A of the accompanying drawings.

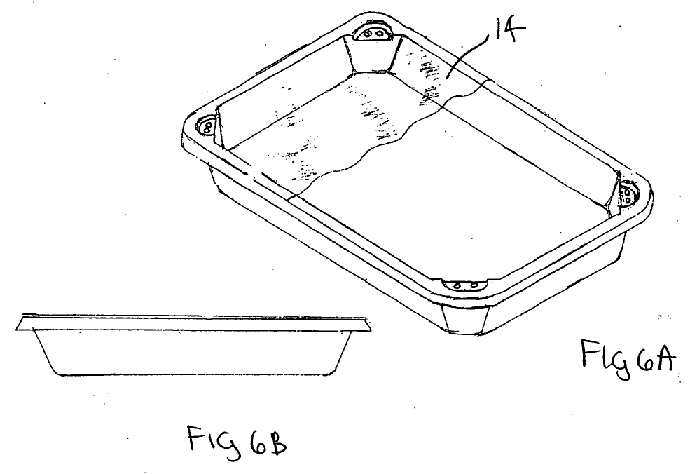

The appropriate lidding sheet which is of a clear plastics material which is to be affixed as in FIG. 6A onwards to the rim by suitable means, eg; adhesive, heat seal, etc. is any food grade material selected from the range of polymers of, Polyethylene (PE), Polypropylene (PP), Polyvinylchloride (PVC), Polyamide (PA), Amorphous Polyethylene Terephalate (APET), or any blends, co-extrusions or laminations of such polymers.

The heat sealing can be by ultrasonic means, adhesive means or heat and pressure means.

A wrap material suitable for lidding and providing the wrap for any of the other embodiments is a suitable food grade plastics wrap selected from the group consisting of polymers of, Polyethylene (PE), Polypropylene (PP), Polyvinylchloride (PVC), Polyamide (PA), Amorphous Polyethylene Terephalate (APET), or any blends, co-extrusions or laminations of such polymers.

It can be seen from the drawings the tray in each instance is depicted more or less in a similar form with a substantially flat base 1 and one or more upstanding peripheral wall 2 having a rim region 3.

The base and indeed the wall(s) can merger with a curve and each or both the base and the wall(s) may be patterned or otherwise contoured with a relief for tray strengthening or exudate concealment purposes.

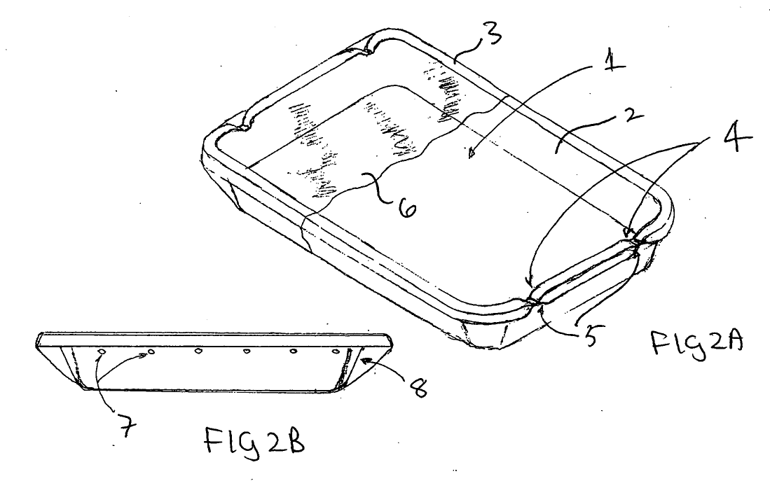

In the case of FIG. 2A the rim region 3 has set down thereinto (at the moulding of the tray form) two recesses 4 on each opposed end wall. Such recesses also move inwardly of the outer perimeter of the skirted flange that forms the rim, (ie; set in at 5) so that when wrapped with the wrapping material 6 with its openings 7 there is a possibility of air movement between the wrap and the tray walls to access the interior of the tray where the meat will be packed either directly on the base or on any suitable soaker pad.

FIG. 2B shows a tray surrounding chamber 8 by which there can be gas interchange flow about the tray which communicates the openings 7 with the gap 50 between wrap 6 and the set downs and set ins 4 and 5 of the rim.

The arrangement as in FIGS. 1A and 1B is similar to that in the aforementioned Transhumance patent in that there are always openings 9 set down in a plateau. FIG. 1A shows such openings and pairs on each of the plateaux 10.

The material of a tray as in FIG. 1A is oxygen retaining, eg; polymers of, General Purpose Polystyrene (GPPS), High Impact Polystyrene (HIPS), Amorphous Polyethylene Terephalate (APET), Crystallised Polyethylene Terephalate (CPET), Polypropylene (PP), Polyethylene (PE) or any blends, co-extrusions or laminations of such polymers whether foamed by means of direct gas injection or chemical reaction unlike the tray forming materials referred to in the Transhumance patents mentioned previously.

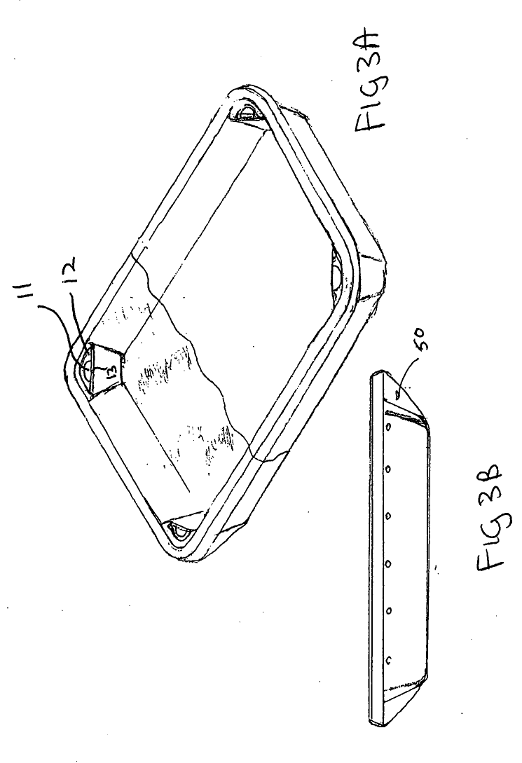

FIG. 3A shows a flap 11 set down in a plateau 12 which occludes the opening but which under the movement of gas flow one way or the other will move sufficiently to allow the gas interchange. Such a flap hinges at 13 but is otherwise separate from the plateau 12.

The wrap and other features of the embodiment of FIGS. 3A and 3B are substantially as described in respect of FIGS. 1A and 1B, ie; the material of the tray is preferably foamed General Purpose Polystyrene (GPPS) or chemically foamed Polypropylene (PP) and the wrap is as previously defined, for example, materials such as polymers of, Polyethylene (PE), Polypropylene (PP), Polyvinylchloride (PVC), Polyamide (PA), Amorphous Polyethylene Terephalate (APET), or any blends, co-extrusions or laminations of such polymers.

The embodiment of FIG. 4A is similar in form as shown in FIGS. 2A and 2B save for the material from which the tray is formed and in this embodiment the tray is formed from a non oxygen retaining material such as polymers of, High Impact Polystyrene (HIPS), Amorphous Polyethylene Terephalate (APET), Crystallised Polyethylene Terephalate (CPET), Polypropylene (PP), Polyvinylchloride (PVC), Polyethylene (PE) or any blends, co-extrusions or laminations of such rigid polymers.

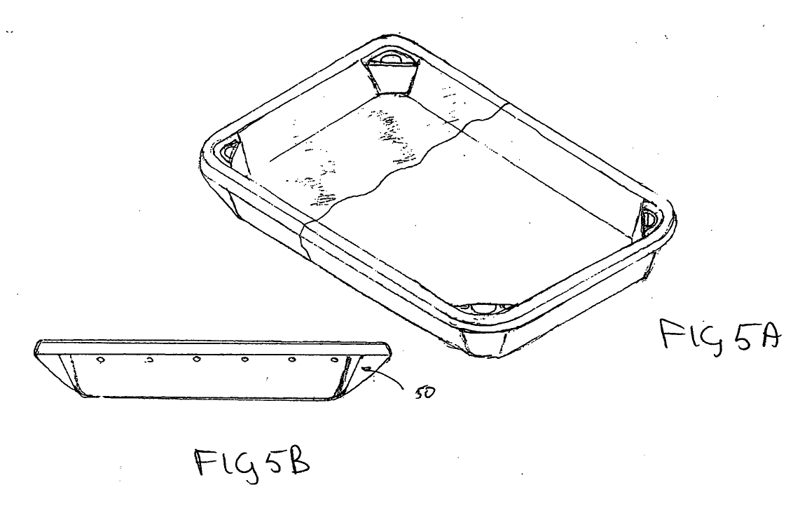

FIGS. 5A and 5B show an alternative to the arrangement of FIGS. 3A and 3B where instead of an oxygen retaining material the tray is formed from a non oxygen retaining material, eg polymers of, High Impact Polystyrene (HIPS), Amorphous Polyethylene Terephalate (APET), Crystallised Polyethylene Terephalate (CPET), Polypropylene (PP), Polyvinylchloride. (PVC), Polyethylene (PE) or any blends, co-extrusions or laminations of such rigid polymers.

FIGS. 6A and 6B shows a variant to the arrangement of FIGS. 1A, 1B and ie; where the tray is formed from an oxygen retaining material such as polymers of, General Purpose Polystyrene (GPPS), High Impact Polystyrene (HIPS), Amorphous Polyethylene Terephalate (APET), Crystallised Polyethylene Terephalate (CPET), Polypropylene (PP), Polyethylene (PE) or any blends, co-extrusions or laminations of such polymers whether foamed by means of direct gas injection or chemical reaction and the lidding is with a lid film such as for example, polymers of, Polyethylene (PE), Polypropylene (PP), Polyvinylchloride (PVC), Polyamide (PA), Amorphous Polyethylene Terephalate (APET), or any blends, co-extrusions or laminations of such polymers sealed to the tray flange about the perimeter of the tray. The lidding film 14 can be sealed peripherally by any one of the following means, ultrasonic, adhesive or heat and pressure.

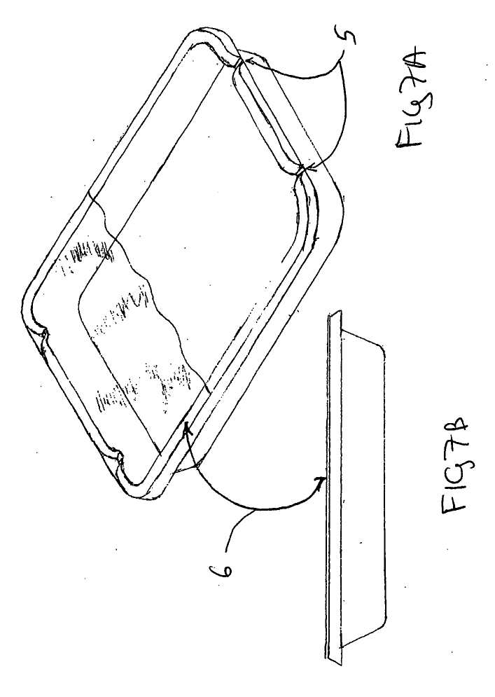

FIGS. 7A and 7B shows a variant of the arrangements of FIGS. 2A, 2B, 4A and 4B but where the tray is formed in an oxygen retaining material such as polymers of, General Purpose Polystyrene (GPPS), High Impact Polystyrene (HIPS), Amorphous Polyethylene Terephalate (APET), Crystallised Polyethylene Terephalate (CPET), Polypropylene (PP), Polyethylene (PE) or any blends, co-extrusions or laminations of such polymers whether foamed by means of direct gas injection or chemical reaction and there is a lidding film of a kind and affixed in a way as described previously in respect of FIGS. 6A and 6B.

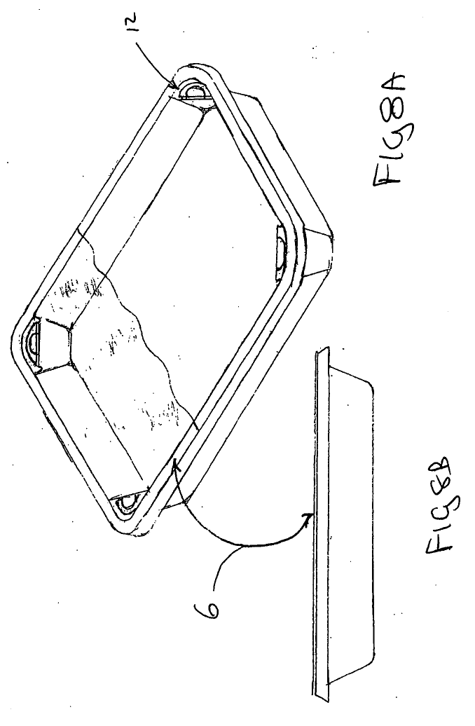

FIGS. 8A and 8B show a further variant on the arrangement of FIGS. 3A, 3B, 5A and 5B, ie; where the tray material is oxygen retaining such as, for example, and there is a lidding film as opposed to a wrap, the lidding form being as previously defined.

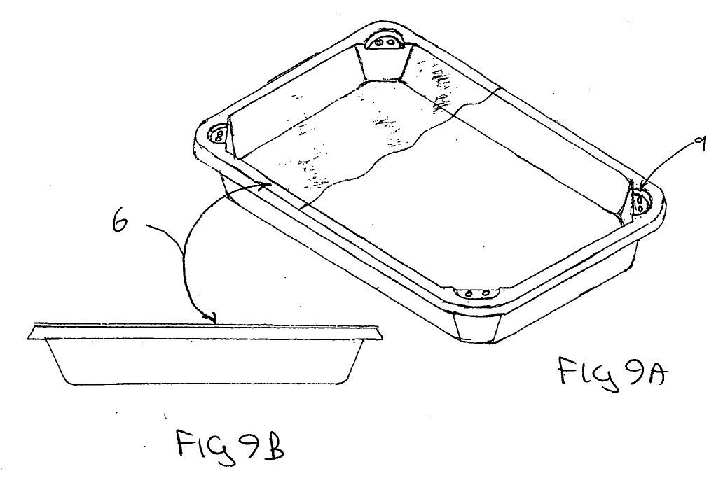

FIGS. 9A and 9B shows yet a further variant of the tray form of FIGS. 1A and 6A, ie; one where the tray material is non oxygen retaining, such as for example, and the lidding is with a lidding sheet as opposed to wrap, the sheet being of a kind and affixed in a manner as previously defined.

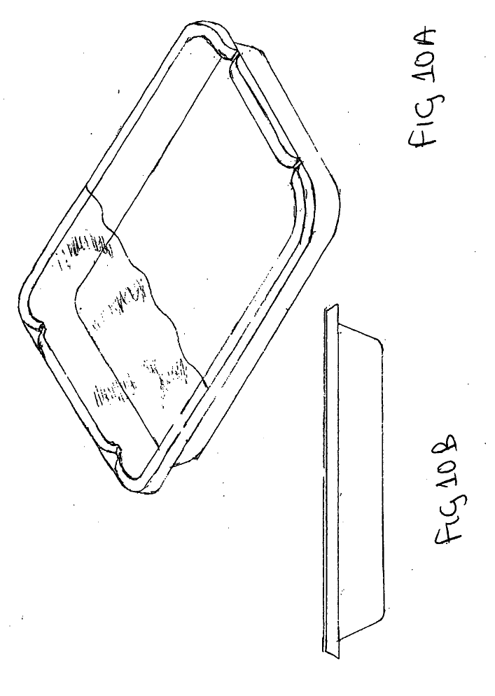

FIGS. 10A and 10B shows still a further variant of the tray form of FIGS. 2A, 4A and 7A, ie; where the tray is formed in an oxygen retaining material such as polymers of, General Purpose Polystyrene (GPPS), High Impact Polystyrene (HIPS), Amorphous Polyethylene Terephalate (APET), Crystallised Polyethylene Terephalate (CPET), Polypropylene (PP), Polyethylene (PE) or any blends, co-extrusions or laminations of such polymers whether foamed by means of direct gas injection or chemical reaction and there is lidding film affixed thereto, the lidding film being of a material and affixed in a manner as previously defined.

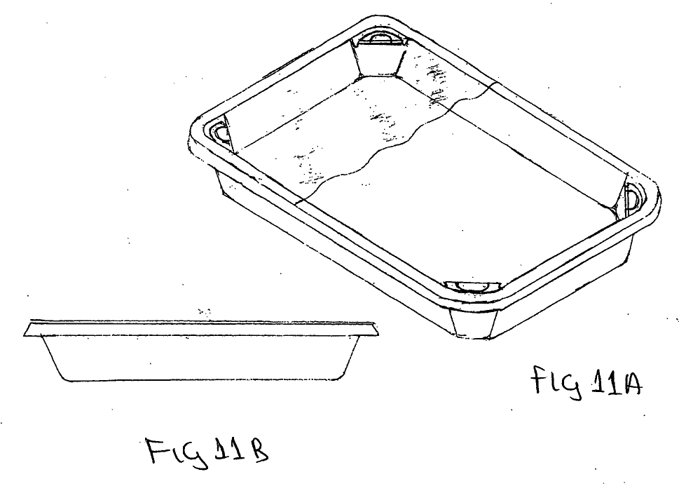

FIGS. 11A and 11B show yet a further variant of the tray form of FIGS. 3A, 5A and 8A, ie; where the tray is formed from a non oxygen retaining material such as polymers of, General Purpose Polystyrene (GPPS), High Impact Polystyrene (HIPS), Amorphous Polyethylene Terephalate (APET), Crystallised Polyethylene Terephalate (CPET), Polypropylene (PP), Polyethylene (PE) or any blends, co-extrusions or laminations of such polymers whether foamed by means of direct gas injection or chemical reaction and it is lidded by a lidding film of a kind and in a manner substantially as previously defined.

By reference to the aforementioned Transhumance patent specifications persons skilled in the art will appreciate how packs in lidded (lid filmed or wrapped) trays of the present invention can be included in a barrier bag which can be flushed fully with a preservative gas such as carbon dioxide (optionally after a drawing of at least a partial vacuum therein) and thereafter be sealed such that the meat package of multiple packs (although it can be a single pack) are exposed to a gas in which the meat will not bloom until such time as there is a gas interchange following the opening of the barrier bag. The procedures set out in the aforementioned Transhumance patents may be utilised and are here included by way of reference.

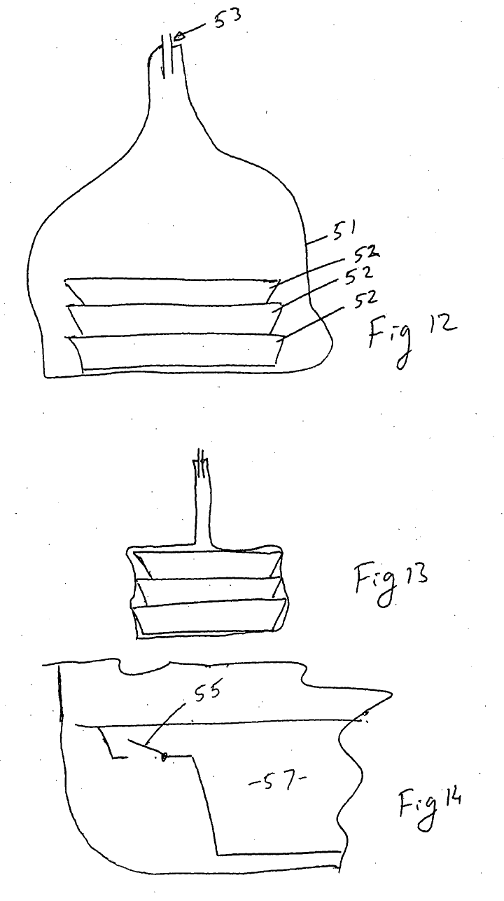

With reference to FIG. 12 there is shown a master pack 51 which may contain one or a plurality of trays 52. The trays may be provided in the master pack 51 in a stacked formation as for example shown in FIG. 12. Once the trays 52 are received in the containment region of the master pack 51 a means to flush via a nozzle 53 may be engaged with the master pack 51 for the removal of air from the containment region of the master pack. Such removal will result in for example the master pack shrinking to a condition as for example shown in FIG. 13. Whilst not all air will be able to be removed from the containment region a substantial amount of air will be removed during such suction. With the provision of the perforations and/or openings as hereinbefore defined to the various configurations of trays, air within the containment regions of the trays will also be removed.

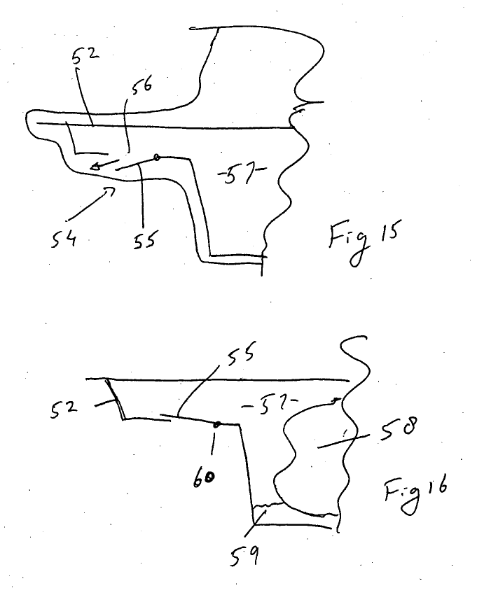

In the version of the tray where the tray includes a valved opening 54 as for example shown in FIG. 15, during such removal of air from the containment region the flap 55 will be positioned relative to the opening 56 to allow for removal of air through the opening generated between the opening 56 and the flap 55 from the containment region 57 of the tray 52. The flap 55 is preferably of a kind which under sufficient pressure can move between sides of the opening 56 and in a suction pressure subjected to the exterior of the containment 57 of the tray 52, the flap 55 will move to the outer side of the containment region 57 and in a positive pressure situation where pressure to the exterior of the tray 52 is greater than the containment region side 57 of the tray, the flap 55 can move to the containment side 57 of the tray as for example shown in FIG. 14. Once the air has been substantially removed from the containment region a replacement preservative gas such as carbon dioxide can be introduced into the containment region. The introduction of a positive pressure into the containment region will induce the flap 55 to move to the containment side 57 of the tray as for example shown in FIG. 14. It is desirable that the flap 55 moves to such a condition since, once the tray 52 is removed from the master pack for the purposes of display of the tray for retail, the flap 55 remains on the containment region side of the tray as a result of the pressure differentials preferably being not sufficient to allow for the transfer of the flap to the opposite side of the opening 56. With the flap remaining in a condition as for example shown in FIG. 16, air ingress into the containment region 56 can occur to allow for blooming of the meat 58 yet still prevent the spillage or reduce the possibility of spillage of any juices or other fluids 59 within the containment region 57 through the opening 56 as a result of such being prevented by the flap 55. The formation of the flap 55 from then moulded material of the tray form to a condition where restrictive movement of the flap between opposite sides of the opening 56 can be achieved in a manner which will be obvious to a person skilled in the art of technology of such foam material. One method is to provide the opening by the cutting of material at the flap region in a direction non perpendicular to the general plane of the opening. An angular cutting of the material to define the flap and opening and yet still allow for a hinge region 60 to be provided for maintaining the flap 55 as part of the tray form can be utilised.

A pack which comprises multiple lidded meat containing trays of the present invention in a master pack (eg; a gas flushed oxygen barrier bag) may in turn be packed in a transportation container. Such transportation container can include a machine or hand erectable carton or case (such as disclosed in Carter Holt Harvey Limited New Zealand Patent Application No. 520535 and New Zealand Registered Design Application No. 402859) or within some plastics crate or case (preferably demountable for return transportation).

The present invention therefore extends to a system of handling meat from slaughter house through to retail outlet which involves the operative use of procedures, systems, trays, lidded tray packs, gas flush packs, and transport packed packs in accordance with the present invention and/or as described herein.

1. A tray including a moulded tray form defining a base, an upstanding peripheral wall or upstanding peripheral walls from the base to define a containment region, and a peripheral rim at the distal extremity of the wall(s), wherein there is set down in the peripheral rim at least one recess adapted to and/or which will allow gas exchange from the containment region of the tray form to the outside of said tray form, and/or vice versa when the peripheral rim is lidded by a lidding means selected from one of
(i) a wrap enveloping said tray form, itself having a ventilation feature for gas exchange through the wrap away from the peripheral rim and the containment region lidding portion of the wrap, and
(ii) a lidding sheet affixed to the peripheral rim but not down into the recess(es) to allow for a ventilation opening to remain via said at least one recess between the containment region and the outside of said tray form.

2. A tray as claimed in claim 1 wherein said peripheral rim defines the general surround to said tray save for at least one said recess set down from said general surround of said peripheral rim being of a kind selected from any one or both of
i. at least one rebate in said peripheral rim and
ii. at least one scallop in said peripheral rim.

3. A tray as claimed in claim 1 wherein said at least one recess is formed by a plateau set down inwardly of the periphery of said tray form in said peripheral rim.

4. A tray as claimed in claim 1 wherein said tray form has a quadrilateral shaped base and wherein at at least one corner at the periphery, at least one said recess is formed by a plateau set down inwardly of the periphery of said tray form in said peripheral rim.

5. A tray as claimed in claim 1 wherein said tray form has a quadrilateral shaped base and wherein at each corner at the periphery, at least one said recess is formed by a plateau set down inwardly of the periphery of said tray form in said peripheral rim.

6. A tray as claimed in claim 1 wherein said upstanding peripheral wall extends from said base, outwardly directed.

7. A tray as claimed in claim 1 wherein said peripheral rim extends outwardly from said upstanding peripheral wall and downwardly therefrom.

8. A tray as claimed in claim 1 wherein said peripheral rim is of a flat transverse cross section.

9. A tray as claimed in claim 1 wherein said peripheral rim is of a curve transverse cross sections.

10. A tray as claimed in claim 1 wherein said lidding sheet claim 12 (original) lies in a plane defined by the rim save for said recesse(s).

11. A tray as claimed in claim 1 wherein perforations extend through the upstanding peripheral wall.

12. A tray as claimed in claim 11 wherein the perforations are provided proximate more to said peripheral rim side of said upstanding peripheral wall than to the base side thereof.

13. A tray as claimed in claim 3 wherein at least one perforation is provided at the recess formed in a plateau setdown.

14. A tray as claimed in claim 1 wherein said tray form is moulded from a non oxygen retaining plastics material.

15. A tray as claimed in claim 1 wherein said tray form is moulded from a non oxygen retaining plastics material including a polymer selected from one of
i. High Impact Polystyrene (HIPS),
ii. Amorphous Polyethylene Terephalate (APET),
iii. Crystallised Polyethylene Terephalate (CPET),
iv. Polypropylene (PP),
v. Polyvinylchloride (PVC),
vi. Polyethylene (PE).

16. A tray as claimed in claim 1 wherein said tray form is moulded and includes a non oxygen retaining plastics material of a blend of polymers including one selected from
i. High Impact Polystyrene (HIPS),
ii. Amorphous Polyethylene Terephalate (APET),
iii. Crystallised Polyethylene Terephalate (CPET),
iv. Polypropylene (PP),
v. Polyvinylchloride (PVC),
vi. Polyethylene (PE).

17. A tray as claimed in claim 1 wherein said tray form is moulded from a non oxygen retaining assembly of plastics material layers including a co laminate layer selected from one of
i. High Impact Polystyrene (HIPS),
ii. Amorphous Polyethylene Terephalate (APET),
iii. Crystallised Polyethylene Terephalate (CPET),
iv. Polypropylene (PP),
v. Polyvinylchloride (PVC),
vi. Polyethylene (PE).

18. A tray as claimed in claim 1 wherein the tray form is moulded from an oxygen retaining plastic.

19. A tray as claimed in claim 1 wherein the tray form is moulded from a foamed plastics material whether foamed by means of direct gas injection or chemical reaction.

20. A tray as claimed in claim 1 wherein the tray form is moulded from an oxygen retaining plastic including a polymers selected form
i. General Purpose Polystyrene (GPPS),
ii. High Impact Polystyrene (HIPS),
iii. Amorphous Polyethylene Terephalate (APET),
iv. Crystallised Polyethylene Terephalate (CPET),
v. Polypropylene (PP), Polyethylene (PE).

21. A tray as claimed in claim 18 wherein said tray form is of a kind which where the oxygen is secured against migration to the meat.

22. A tray as claimed in claim 1 wherein the base is substantially rectangular and the recess(es) are in opposed distal regions of opposed upstanding walls.

23. A meat package which comprises a tray as claimed in claim 1 wherein meat is positioned directly or indirectly on the base and within said containment region said lidding means is a clear plastics material provided over the meat.

24. A meat package as claimed in claim 23 wherein said lidding means is a lidding sheet affixed to the peripheral rim and not providing a wrap of the tray form itself.

25. A meat package as claimed in claim 23 wherein the lidding means is a wrap of a plastics film, and to enable gas interchange there is provided perforation in the wrap below the peripheral rim externally of the tray form.

26. A meat package as claimed in claim 25 wherein the perforation of the wrap are outwardly of the upstanding peripheral wall(s).

27. A meat package as claimed in claim 25 wherein the or additional perforation is provided of said wrap underneath the tray from and wherein there is a transition of the tray form from the base to upstanding peripheral wall(s) that will allow movement of gas between the wrap and the tray form at the base.

28. A meat package as claimed in claim 25 wherein in addition perforations through the tray form itself are provided at the upstanding peripheral wall(s).

29. A tray including a moulded tray form defined by a base, an upstanding peripheral wall or upstanding peripheral walls from the base to define a containment region, and a peripheral rim at the distal extremity of the wall(s), wherein there is set down inwardly of said peripheral rim at least one valved opening adapted to and/or which will allow gas exchange from the containment region of said tray form to the outside of said tray form, and/or vice versa, when the peripheral rim is lidded by a lidding means selected from one of
(i) a wrap enveloping said tray form, itself having a ventilation feature for gas exchange through the wrap away from the peripheral rim and the containment region lidding portion of the wrap, and
(ii) a lidding sheet affixed to the peripheral rim but not down to the valved opening(s) to allow for a ventilation opening to remain via said at least one valved opening(s) between the containment region and the outside of said tray form.

30. A tray as claimed in claim 29 wherein tray form is moulded from a non oxygen retaining plastics material.

31. A tray as claimed in claim 29 wherein said tray form is moulded from a non oxygen retaining plastics material including a polymer selected from one of
(i) High Impact Polystyrene (HIPS),
(ii) Amorphous Polyethylene Terephalate (APET),
(iii) Crystallised Polyethylene Terephalate (CPET),
(iv) Polypropylene (PP),
(v) Polyvinylchloride (PVC),
(vi) Polyethylene (PE).

32. A tray as claimed in claim 29 wherein said tray form is moulded and includes a non oxygen retaining plastics material of a blend of polymers including one selected from
i. High Impact Polystyrene (HIPS),
ii. Amorphous Polyethylene Terephalate (APET),
iii. Crystallised Polyethylene Terephalate (CPET),
iv. Polypropylene (PP),
v. Polyvinylchloride (PVC),
vi. Polyethylene (PE).

33. A tray as claimed in claim 29 wherein tray form is moulded from a non oxygen retaining assembly of plastics material layers including a co laminate layer selected from one of
i. High Impact Polystyrene (HIPS),
ii. Amorphous Polyethylene Terephalate (APET),
iii. Crystallised Polyethylene Terephalate (CPET),
iv. Polypropylene (PP),
v. Polyvinylchloride (PVC),
vi. Polyethylene (PE).

34. A tray as claimed in claim 29 wherein the tray form is moulded from an oxygen retaining plastic.

35. A tray as claimed in claims 34 wherein the tray form is moulded from a foamed plastics material whether foamed by means of direct gas injection or chemical reaction.

36. A tray as claimed in claims 34 wherein the tray form is moulded from an oxygen retaining plastic including a polymers selected form
i. General Purpose Polystyrene (GPPS),
ii. High Impact Polystyrene (HIPS),
iii. Amorphous Polyethylene Terephalate (APET),
iv. Crystallised Polyethylene Terephalate (CPET),
v. Polypropylene (PP), Polyethylene (PE).

37. A tray as claimed in claim 34 wherein said tray form is of a kind where the oxygen is secured against migration to the meat.

38. A tray as claimed in claim 29 wherein the lidding means is provided by a wrap of a clear plastics film.

39. A tray as claimed in claim 29 wherein said at least one opening is valved by a flap of the moulded material and substantially occludes the opening yet is capable of being moved resiliently to less occlude the opening under the action(s) of any induced gas exchange.

40. A meat package which comprises a tray as claimed in claim 29 wherein meat is positioned directly or indirectly on the tray base in said containment region and a said lidding means of a clear plastic film is provided over the meat.

41. A meat package as claimed in claim 40 wherein said lidding means is a lidding sheet affixed to the peripheral rim and not providing a wrap of the tray form itself.

42. A meat package as claimed in claim 40 wherein the lidding means is a wrap of a plastics film, and to enable gas interchange there is provided perforation in the wrap below the peripheral rim externally of the tray form.

43. A meat package as claimed in claim 42 wherein the perforation of the wrap is outwardly of the upstanding peripheral wall(s).

44. A meat package as claimed in claim 42 wherein the or additional perforation is provided of said wrap underneath the tray form and wherein there is a transition of the tray form from the base to upstanding peripheral wall(s) that will allow movement of gas between the wrap and the tray form at the base.

45. A meat package as claimed in claim 42 wherein in addition perforations through the tray form itself are provided at the upstanding peripheral wall(s).

46. A tray including a moulded tray form defined by a base, an upstanding peripheral wall or upstanding peripheral walls from the base to define a containment region and a peripheral rim at the distal extremity of the wall(s), wherein there is set down internally of the peripheral rim at least one valved opening adapted to and/or which will allow gas exchange from the containment region of the tray form to the outside of said tray form, and/or vice versa, when the peripheral rim is lidded by a lidding means selected from one of:
(i) a wrap, enveloping said tray form, itself having a ventilation feature for gas exchange through the wrap away from the rim and the lidding portion of the wrap, and
(ii) a lidding sheet affixed to the peripheral rim but not down to the valved opening(s).

47. A tray as claimed in claim 45 wherein the or each valved opening is set down into a plateau formed in said upstanding peripheral wall(s).

48. A tray as claimed in claim 47 wherein said base is rectangular in shape and said plateau is in a corner of said upstanding peripheral wall(s) inwardly and down from the peripheral rim.

49. A tray as claimed in claim 46 wherein the valving element of each valved opening is a flap substantially in the plane or curvature of the opening which substantially occludes the opening except when moved from such an occluding condition by gas exchange flows, such movement preferably being resilient.

50. A tray as claimed in claim 46 wherein each such valved opening is of a form being a perforation through said tray form with which a flap is movable relative thereto to move between a perforation covering to a perforation uncovering condition to respectively close and open said valved opening and can be in addition to, or instead of, any other means to allow gas interchange inwardly and outwardly from the lidded tray in use.

51. A fresh packaged meat on a tray and/or on a soaker pad of a tray as claimed in claim 1, the tray being lidded.

52. A fresh packaged meat on a tray and/or on a soaker pad of a tray as claimed in claim 29, the tray being lidded.

53. A fresh packaged meat on a tray and/or on a soaker pad of a tray as claimed in claim 46, the tray being lidded.

54. A fresh packaged meat as claimed in claim 51 wherein the lidding is with a lidding sheet or wrap.

55. A fresh packaged meat as claimed in claim 52 wherein the lidding is with a lidding sheet or wrap.

56. A fresh packaged meat as claimed in claim 53 wherein the lidding is with a lidding sheet or wrap.

57. A pack of meat of a kind where the meat is capable of blooming in the presence of oxygen, said pack comprising a container sealed to exclude ambient air, at least one meat package as claimed in claim 23 included within said container, and an atmosphere in the container and the or each meat package which is low or devoid in gaseous oxygen.

58. A pack of meat of a kind where the meat is capable of blooming in the presence of oxygen, said pack comprising a container sealed to exclude ambient air, at least one meat package as claimed in claim 40 included within said container, and an atmosphere in the container and the or each meat package which is low or devoid in gaseous oxygen.

59. A pack of meat of a kind where the meat is capable of blooming in the presence of oxygen as claimed in claim 57, wherein the gas environment internally of the container is high in carbon dioxide.

60. A pack of meat of a kind where the meat is capable of blooming in the presence of oxygen as claimed in claim 58, wherein the gas environment internally of the container is high in carbon dioxide.

61. A pack of meat of a kind where the meat is capable of blooming in the presence of oxygen as claimed in claim 57, wherein said container is a barrier bag that has been sealed.

62. A pack of meat of a kind where the meat is capable of blooming in the presence of oxygen as claimed in claim 58, wherein said container is a barrier bag that has been sealed.

63. (canceled)
